(19) United States
(12) Patent Application Publication
(10) Pub. No.: US 2001/0032093 A1
(43) Pub. Date: Oct. 18, 2001

(54) Method to assist consumers to make death care arrangements on-line

(76) Inventor: Mitchell S. Segal, Williston Park, NJ (US)

Correspondence Address: PENNIE & EDMONDS LLP, 1667 K STREET NW, SUITE 1000, WASHINGTON, DC, 20006

(21) Appl. No.: 09/758,197

(22) Filed: Jan. 12, 2001

Related U.S. Application Data
(60) Provisional application No. 60/176,071, filed on Jan. 14, 2000.

(51) Int. Cl. G06F 17/60

(52) U.S. Cl. 705/1

(57) ABSTRACT

A method for making a funeral arrangement is provided. The method includes the steps of developing a plurality of funeral arrangement options from a plurality of funeral service providers, and transmitting information relating to the plurality of funeral arrangement options to a remote computer. The method further includes the steps of allowing a user at the remote computer to select a subset of the plurality of funeral arrangement options, matching the selected subset to the plurality of funeral arrangement options, and transmitting the selected subset to the funeral service provider from which the selected subset was collected. A corresponding system is also provided.

### FIELD OF THE INVENTION

The present invention relates to a method and system for making funeral arrangements over the Internet.

### BACKGROUND OF THE INVENTION

At the time of bereavement most consumers are vulnerable due to the death of a loved one as they are unfamiliar with the services offered and the purchasing process in the funeral service industry. Also, few people are familiar with a particular funeral home unless they have had prior dealings with a funeral home (e.g. for a relative) or it is geographically located within close proximity to the living individual's residence (which may not be in close proximity to the domicile or preferred final resting place of the deceased). Furthermore, funeral homes can be non-inviting retail locations that consumers do not feel comfortable visiting while making purchasing decisions. As a result, people are typically not aware of the choices among competing establishments, the price differentials that exist within the industry or the ability to make prearrangements and benefits from prearranging for one's death care.

Companies in the ‘death services’ industry typically provide families with one or more products and services in three principal groups: (1) ceremony and tribute, usually in the form of a funeral or memorial service; (2) disposition of remains, either through burial or cremation; and (3) memorialization, through monuments, markers or inscriptions. This service industry is generally a mix of funeral homes and cemeteries that are independently owned and a growing remainder of which are owned among a handful of public companies and/or congregants. The independently owned entities are highly fragmented, with small, family-owned firms owning one or a few funeral homes or cemeteries in a single community. As the ‘death services’ industry moves toward consolidation, the independent funeral homes, cemeteries and service providers must compete with larger competitors having greater resources. Thus, it is desirable for independent funeral homes to achieve a wider audience and to protect their profit margins.

At the same time, customers are grappling with rising costs, as the move towards consolidation in the industry thus far has not resulted in lower prices. For example, funeral homes typically mark up casket prices by 300% to 500%, the casket often being the most expensive part of the funeral.

In response to the rising costs, various new services are emerging. Funeral service coops have been formed, which operate with minimal advertising overhead. Also, a handful of discount casket chains have sprung up where the consumer can shop in a showroom, call an 800 number or order specific items on the Internet. Some companies offer 24 hour delivery service. Also, cremation is becoming increasingly popular as a cheaper alternative to burial. Nonetheless, consumers currently have no way effectively to shop for a full range of funeral and death related arrangements or to shop effectively for cost effective alternatives.

As a result of changes in the industry, independent funeral homes have faced increased pressure to maintain profitability while dealing with low cost alternatives and competitive pressures. For example, traditional casket companies have developed full lines of cremation-related containers and urns and offer programs to funeral directors to teach them to market cremation services. At least one facility has been developed that offers a chapel, funeral home and a park dedicated to cremation ceremonies. Small operators overwhelmingly do not have Web sites. While morticians scorn the piece sales and changes in the industry, they increasingly realize they must compete. However, managers typically do not have any experience selling over the Internet. Also, many do not trust new technologies enough to spend money creating their own Web sites. Thus a system is desired that will allow them to participate in an on-line program that makes it easy for consumers to find service products, easy to buy from them, and is inexpensive to implement. It is also desired that the system offer a nationwide base, with a variety of affiliated product and service providers.

In summary, it is desirable for companies in the ‘death services’ industry to ameliorate these negative customer experiences and deliver the highest quality and widest array of services at the most reasonable and advantageous prices and effectively market such services in competition with national chains.

### SUMMARY OF THE INVENTION

The present invention provides a method for making a funeral arrangement comprising: developing a plurality of funeral arrangement options; transmitting information relating to the funeral arrangement options to a remote computer; allowing a user to select a subset of funeral arrangement options; matching the selected subset to the plurality of funeral arrangement options; and transmitting the selected subset to a funeral service provider from which the selected subset was collected. In a further enhancement, the method includes transmitting the matched selections to the remote computer, to thereby allow the user to make further refinements on the selected subset of the options. In one embodiment, the step of transmitting information to the remote computer includes: transmitting an electronic form to be filled out at the remote computer.

In a further enhancement, the method allows creation of a database regarding price of services, quality of services, and geographic availability of services, thus facilitating consumer choice based on any one or more such criteria.

In another embodiment, the funeral arrangement options include preparing at least one of a funeral service, a wake service, a burial site or a cremation. In this embodiment, if the funeral service is selected by the user, the funeral arrangement options further include preparing the funeral service at one of funeral home, house of worship and burial site. If the house of worship is selected by the user, the funeral arrangement options further include holding the funeral service under one of a plurality of religious denominations. If the wake option is selected by the user, the funeral arrangement options further include preparing the wake with an open or closed casket.

In a further enhancement, the method allows prearrangement of death care plans through either purchase or financing of insurance products in compliance with applicable state laws.

In a further enhancement, the method includes providing price information to the remote computer based on the selected subset of the plurality of options.

Also disclosed is a system for making a funeral arrangement comprising a database configured to store a plurality of funeral arrangement options collected from a plurality of funeral service providers and a server computer coupled to the database and configured to perform the method as mentioned above.

### BRIEF DESCRIPTION OF THE DRAWINGS

FIG. 1 is a block diagram showing an overview of a funeral service management system according to the present invention;

FIG. 2 is a block diagram of a database management system according to the present invention;

FIG. 3 is a schematic diagram of a main web site according to the present invention;

FIG. 4 is a flowchart depicting a hierarchy of the web site of FIG. 3; and

FIGS. 5-12 are block diagrams depicting combinations of service packages and options.

### DETAILED DESCRIPTION OF THE INVENTION

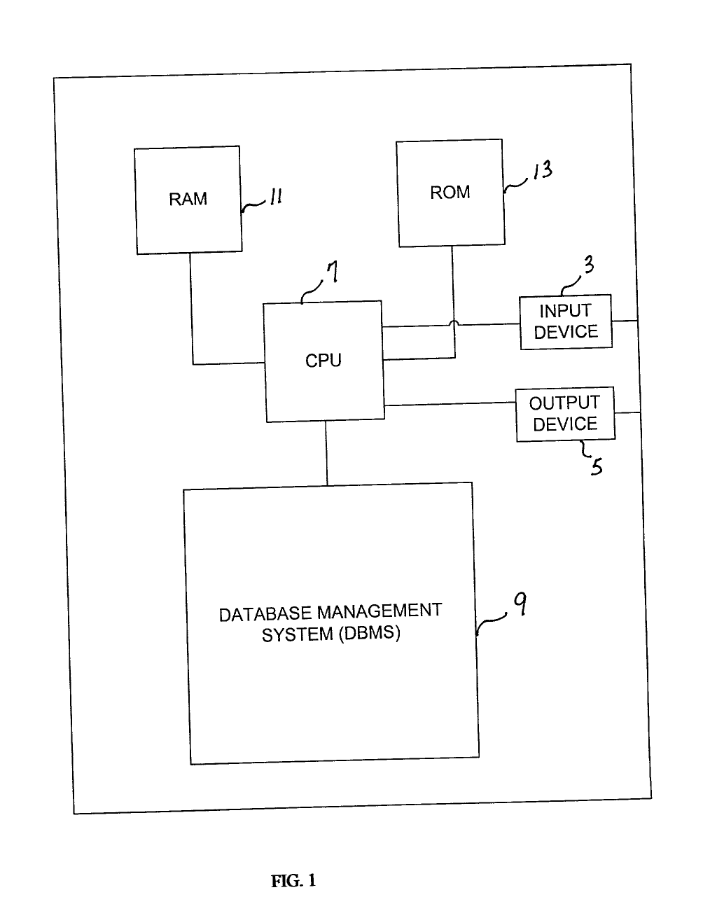

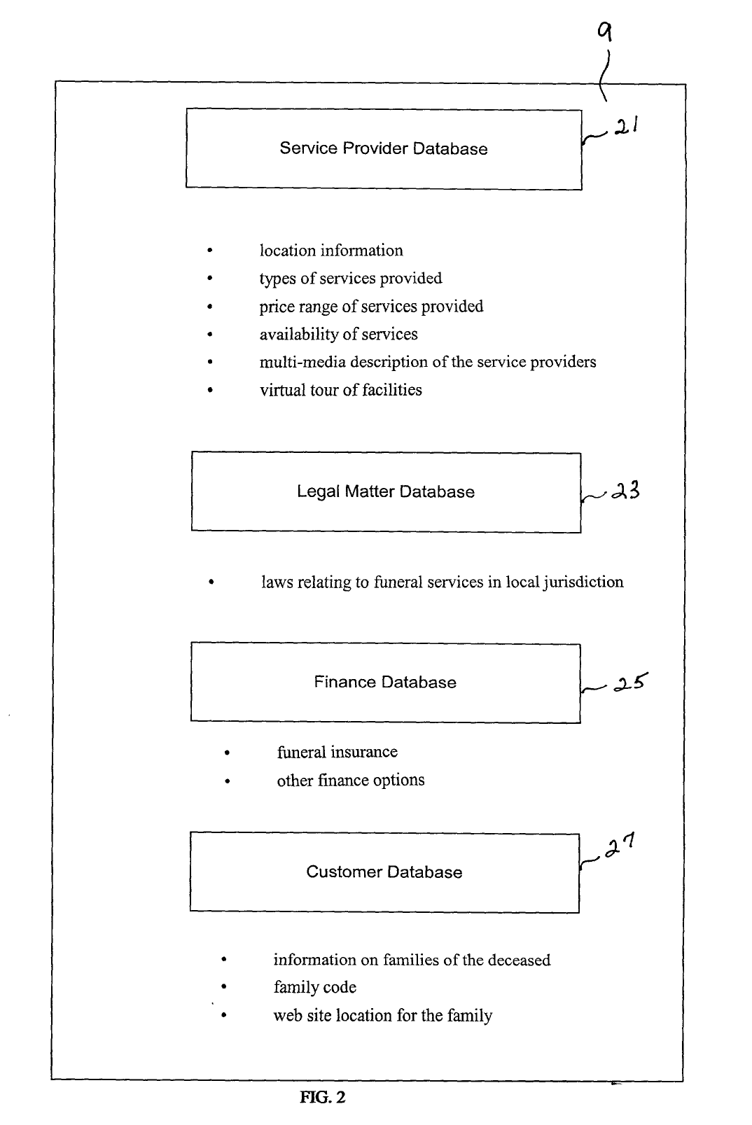

Referring now to the drawings, the present invention includes a funeral service management system (FSMS) 1, for example, such as illustrated in FIG. 1. The FSMS 1 is preferably a computer system that includes an input device 3, an output device 5, a processor 7 with associated software, a database management system 9 and necessary memories such as random-access-memory (RAM) 11 and read-only-memory (ROM) 13. As known in the art, the above discussed components are not required to be implemented as separate units, but can be combined in various ways and may include software and hardware. In general, preferably, FSMS is implemented as a computer server selected based on performance and implementations as known in the art. Also, a network of computers and a special database server may be employed based on performance and implementations as known in the art.

The input device 3 is preferably a communication device that can receive electronic messages from remote computers. The input device 3 may also include a keyboard or other input devices such as a scanner as known in the art. The output device 5 is preferably a communication device that can forward messages to remote locations. The output device 5 may also include a printer or such devices as known in the art. Preferably, the input and output devices provide communication over the Internet using common communication protocol, such as the Hypertext Markup Language (HTML). It should also be noted that the input and output device can also be embodied in a modem as known in the art.

The processor 7 executes software applications that include funeral service arrangement methods (FSAM) as discussed subsequently. The preferred system can also include other memories and off-the-shelf software applications necessary to properly operate the FSMS such as operating systems. Preferably, the FSMS includes all conventional components of an Internet web server. It may, however, also support other communication and storage system capabilities as known in the art for such a server. The processor 7 is preferably a microprocessor that allows software modules such as described above to run thereon.

In particular, the FSMS can also be implemented in a server/client environment or in accordance with a distributed object system such as Common Object Request Broker Architecture (CORBA) as known in the art. The database 9 can be implemented using customized database management systems or conventional database management systems such as ORACLE®, SYBASE® or other similar products. Standard spread sheet software programs may also be used for the database 9. Furthermore, the database 9 can have more than one database to store customer information and funeral related information on different databases.

The database management system 9 includes a number of databases. Preferably, the database management system 9 includes a service provider database 21, a legal matter database 23, a finance database 25 and customer database 27. Other additional databases can also be provided in order to fully service the FSAM.

The service provide database 21 stores information relating to location information of the individual service providers, types of services provided by each of the service providers, price information of the services provided, availability of the services provided and/or multi-media descriptions of the services provided. The multi-media description may include video clips providing virtual tours of facilities of the service providers.

The legal matter database 23 stores information relating to regulations of funeral homes in local, state or federal jurisdictions.

The finance database 25 stores information relating to funeral service insurance and/or other funeral finance options.

The customer database 27 stores information relating to families of the deceased, any family access code to their private database location, and/or web site location information for the family. The private database and private web sites are provided by the FSAM.

The present invention provides a novel method in delivering products and services to the public when dealing with the subject of death. The present invention centralizes a collection of funeral-related commerce, content, and community offerings to assist consumers in researching, evaluating, and buying death industry products and services. Specifically, the present invention's is especially well suited for providing the following products and services: funeral and/or burial services; cremation; sales of cemetery plots; financing a funeral or burial; both for immediate needs and pre-arrangements through either the purchase of insurance products and/or the transfer of moneys into trust and/or consumer financing and/or immediate payment by check or credit; making pre-arrangements for a funeral; making sales of caskets, burial vaults, urns, monuments, markers, and inscriptions; making floral arrangements; making limousine arrangements; using a funeral coach; providing obituaries; sending condolence messages; sending acknowledgment cards; creating memorial folders or prayer cards; sending flowers; creating a virtual memory; making charitable contributions; arranging the transfer of the deceased to the funeral home; arranging embalming, dressing, cosmetology and other care of the deceased; arranging use of visitation rooms; providing general use of the facilities for a funeral service; and providing professional support and administrative staff assistance. Consequently the users can arrange for a complete funeral service for a loved one more quickly, make better-internal decisions and make an unpleasant experience simpler, faster and less traumatic.

Preferably, the present invention provides numerous products and services from Member Merchants, such as funeral homes and related product providers, in order to provide the user with an acceptable retail base. Also, the present invention preferably provides independence from any one service provider so that information seekers may be directed to an optimal product in the relevant geographic area that meets their needs, and an optimal source from which it can be obtained. In this regard, preferably the present invention entails no relationship or affiliation with any one corporate provider in favor of entering into contracts with independent providers or groups of independent providers.

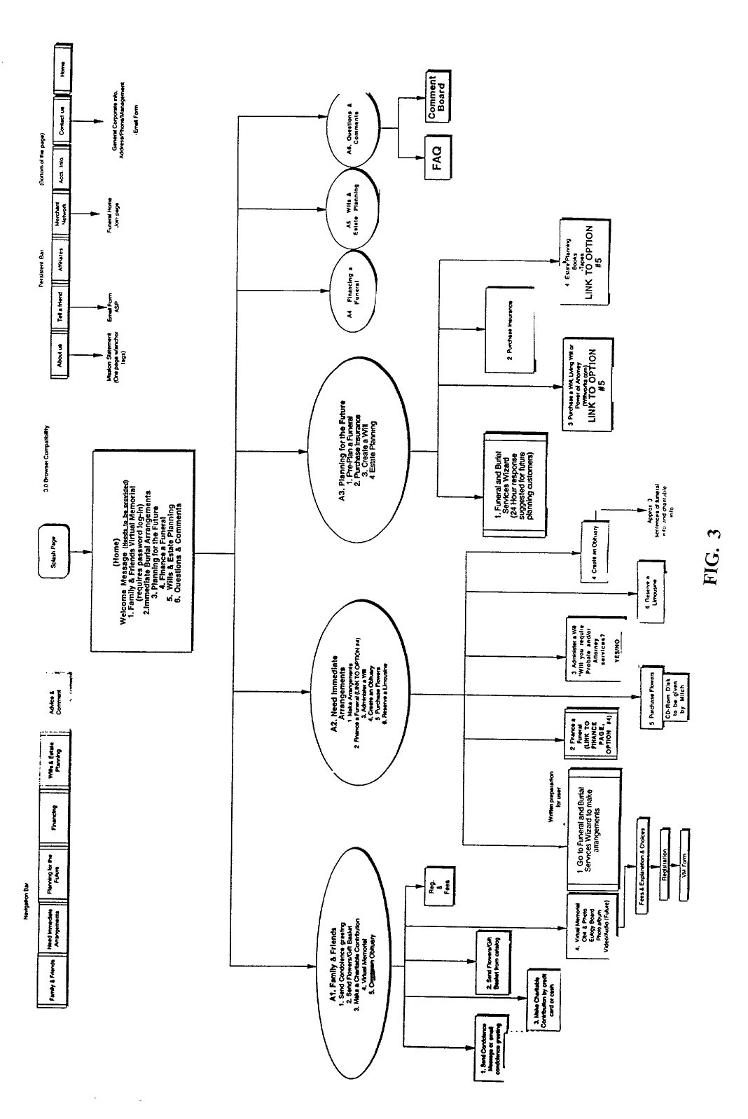

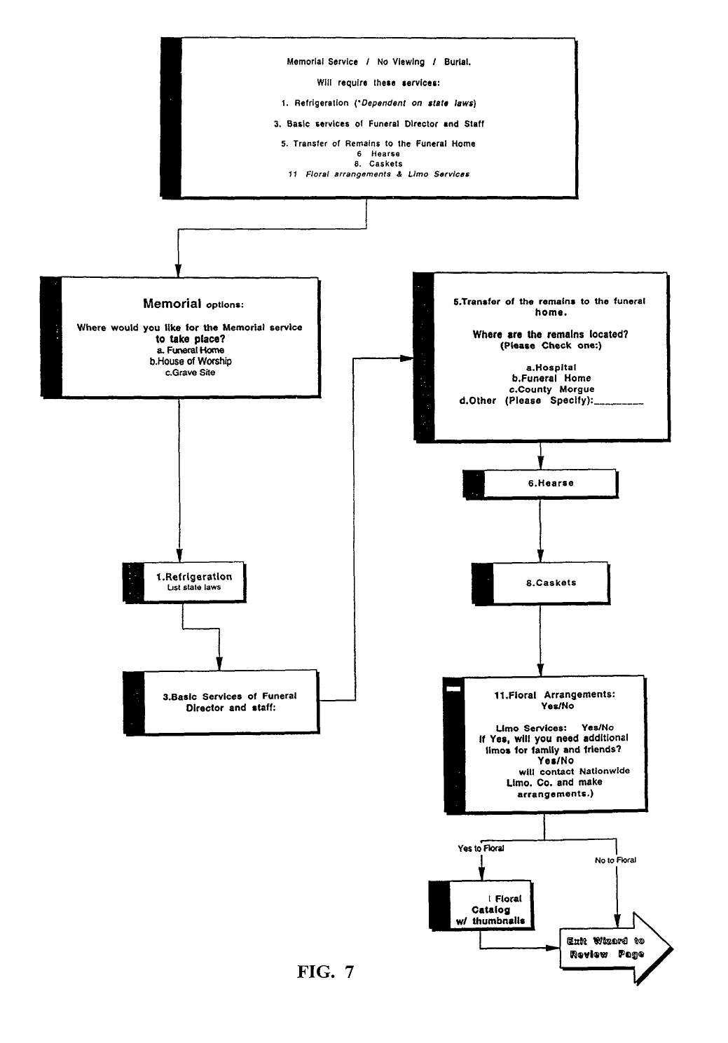

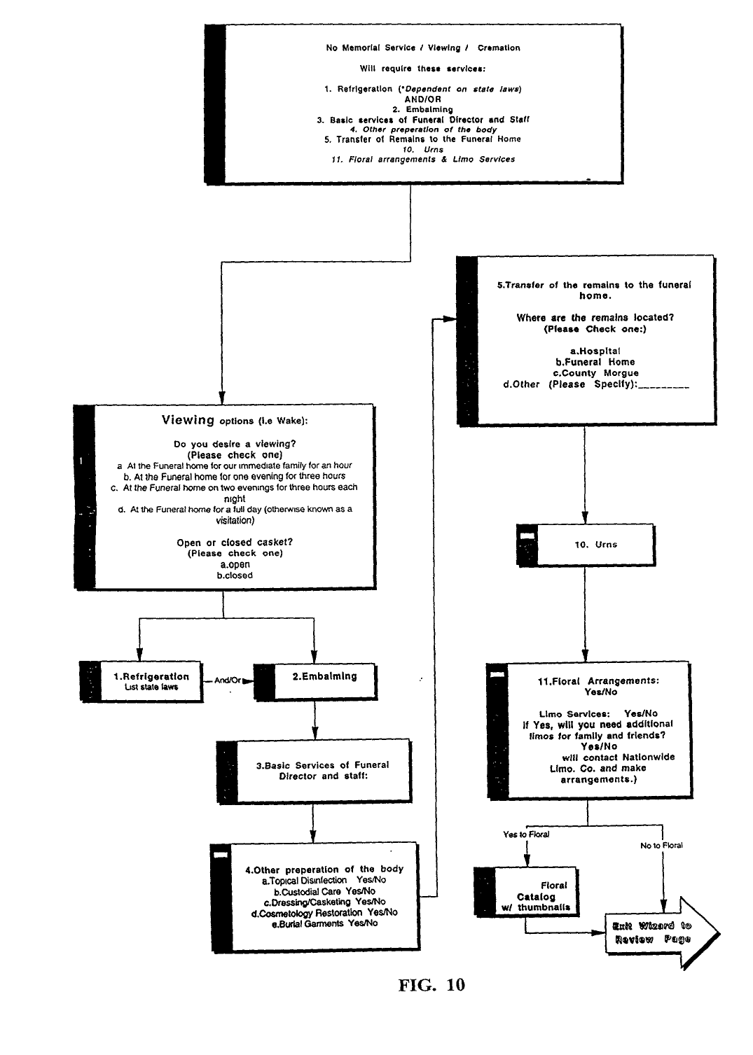

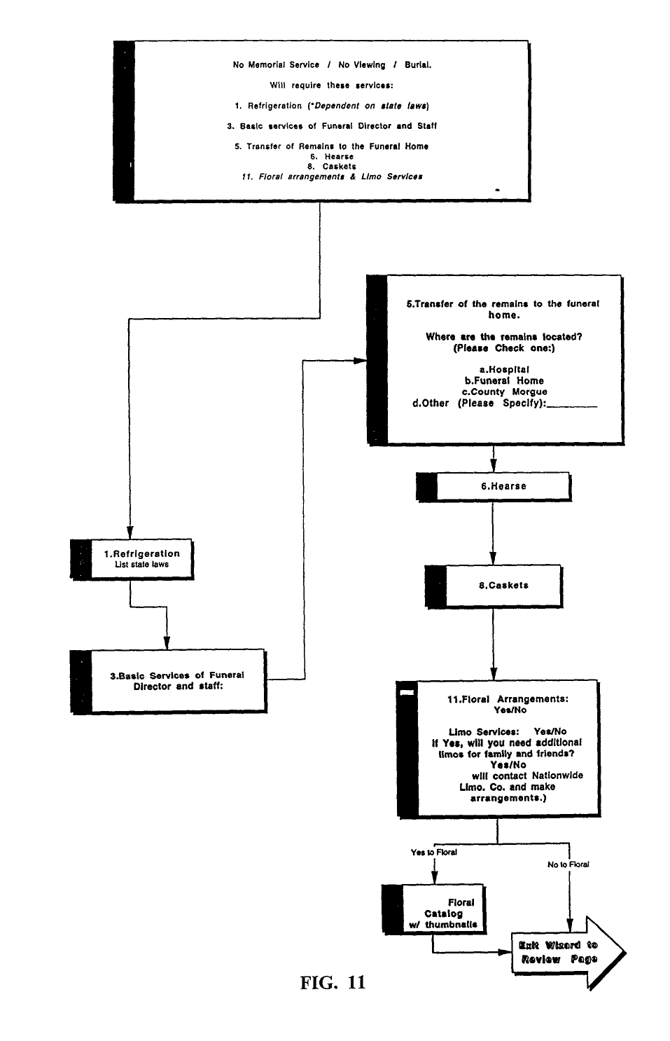

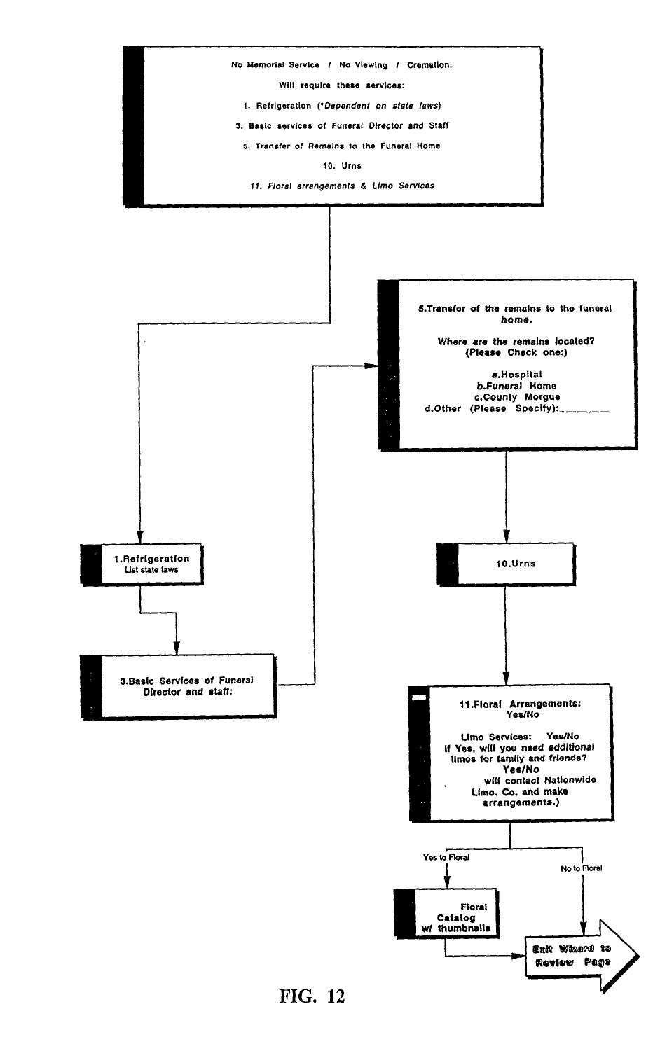

The FSAM includes a main web site (MWS), that provides various options as discussed below in connection with FIGS. 3-12.

FIG. 3 illustrates a schematic representation of a preferred MWS, including service options in the present invention, all or part of which are provided in the MWS. When consumers arrive at the MWS they are greeted by a short welcome message and a directory of service options grouped in a convenient format categorized to fulfill consumer needs. For example, in a preferred embodiment, the services may be grouped to tailor to: family and friends A1, consumers that need to make immediate arrangements A2, consumers planning for the future A3, consumers financing a funeral A4, consumers in search of advice or wishing to provide comments A6. Preferably, the MWS does not link to any external web site for ancillary services so that the entire transaction can be controlled from the MWS and the consumer does not get lost from the MWS.

In a preferred embodiment, the invention also permits consumers, including family and friends A1, to avail themselves of numerous non-essential service options. For instance, consumers are able to send electronic condolence messages, such as via e-mail or web postings, to the family of the deceased or other mourners. A consumer may also purchase a traditional sympathy card or virtual sympathy card and either e-mail or send the card. Family and friends may also order and send flowers and or gift baskets to mourners. The consumer may select from a variety of available flower arrangements and basket configurations in an online catalog which displays products provided by independent flower/basket retailers, for instance in the form of thumbnail figures accessible from, and stored in, the service provider database 21. Consumers can also submit pictures and audio to the MWS which will be turned into a virtual memorial. Such users, including family and friends, can be given a code and/or password to enter a section of the Web site pertaining to the deceased and view the virtual memorial. Videotapes of the services for those friends and family who were unable to attend the funeral in person may also be provided.

The present invention may also incorporate technology such that mourners can attend a service or a live memorial. In this regard, the present invention may provide streaming video to accommodate the need for viewing over the internet. Also, consumers are preferably able to write an obituary which will be kept and stored in customer database 27, as a virtual obituary. For all the above options, consumers may also be provided the same options of services by telephone, e-mail, fax or any other known communications means.

Consumers are also able to submit to the MWS information concerning the services received from any providers, including by way of example, expressing satisfaction or dissatisfaction with the quality of the services provided. Such consumer ratings may be correlated with the cost of such services. Such consumer ratings can then be maintained in the service provider database 21.

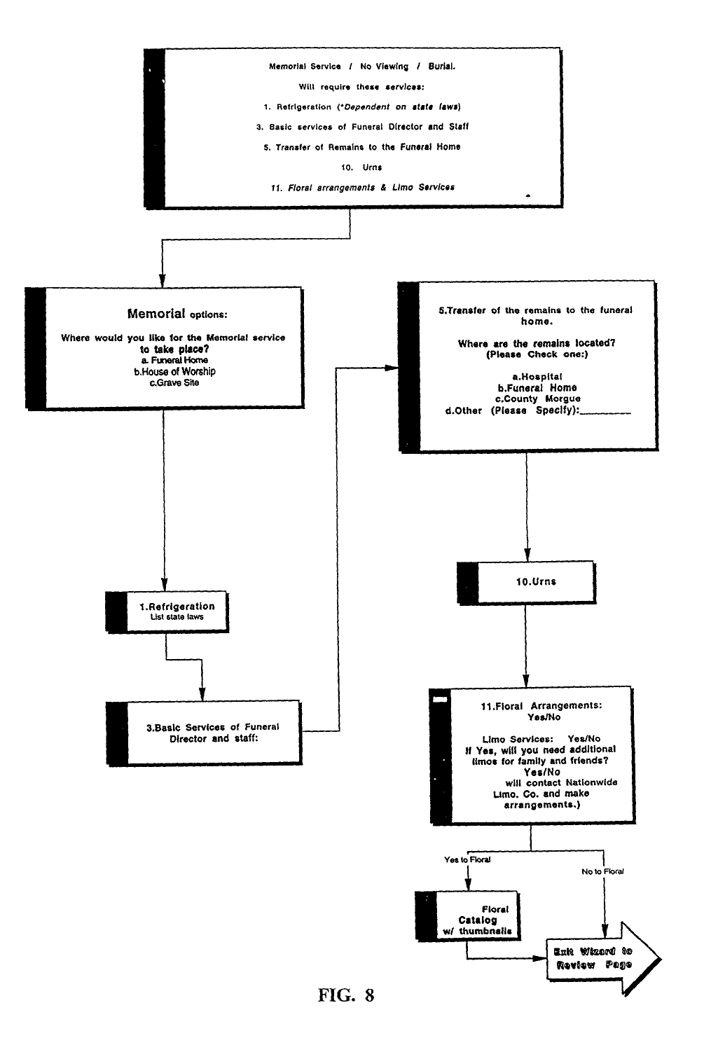

Consumers wishing to make immediate arrangements A2, are provided with options to arrange a funeral and/or burial services; to make arrangements online; to finance a funeral, which is linked to options provided in FIG. 8. A service request form is completed denoting the selected options. Preferably, all of the options have a corresponding price that is simultaneously displayed to the user as the selection is made. The options may also include ratings information from the service provider database based on prior input from consumers of such services. Consumers then process the form containing their choices and additionally input either a zip code or county where they would like the services performed as well as their religious denomination, if any. Consumers then submit the form and the present invention will match their desired services with a local Member Merchant serving the geographic area they desire based upon the services, products and prices offered by that particular merchant. The present invention permits the matching function to be made based on any one or more criteria, including geographic proximity, price and quality. In an embodiment of the invention, the consumer is able to select the desired weights assigned to each such criterion.

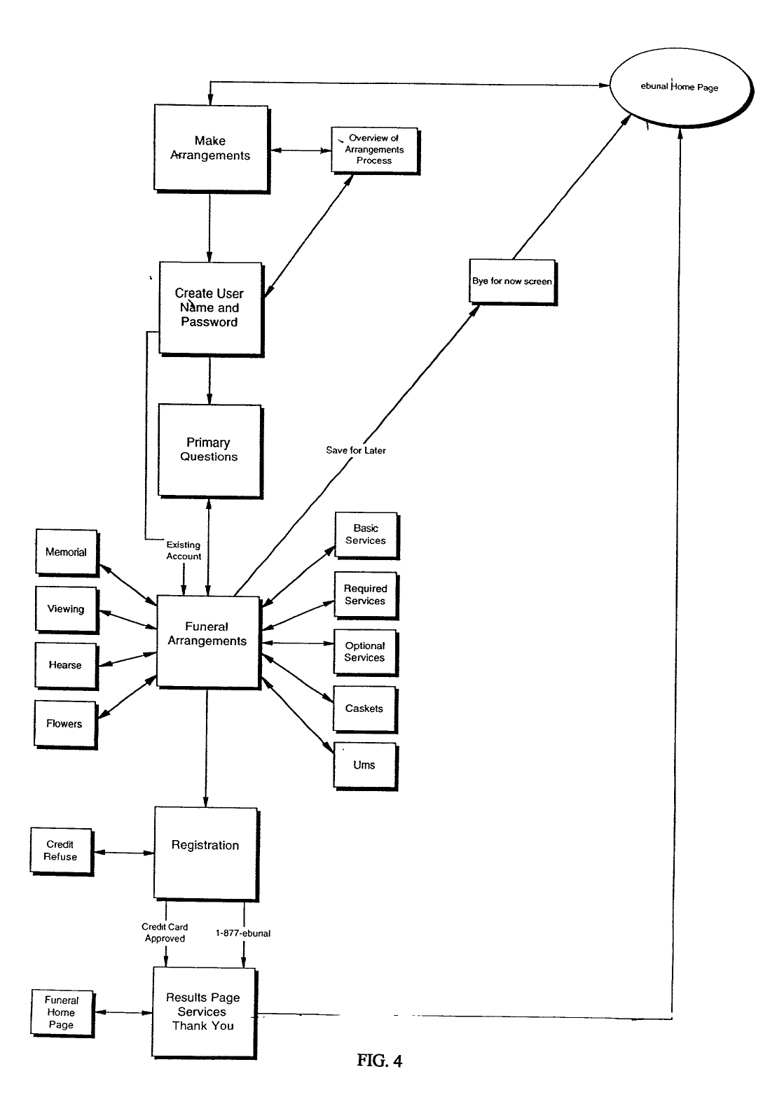

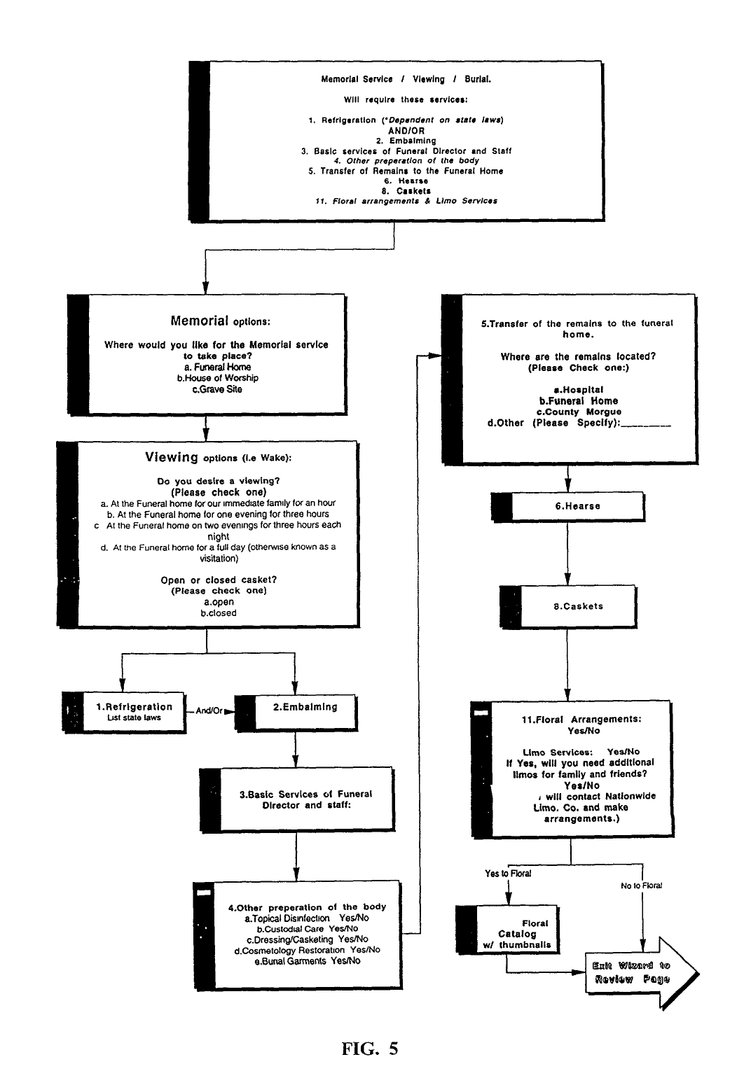

Referring to FIG. 4, as a user accesses the MWS on his/her local computer, the MWS provides information on the overview of arrangement process 105 or may allow the user to make arrangements 103. If the user does not have an existing account, then the user is asked to create a new account including user name and corresponding password 107. Subsequently, the user can also be asked to provide answers to primary questions, such as religion and residence, 109. After opening the account or if the user has an existing account, the user is allowed to make funeral arrangements 111. The funeral arrangements can include: a memorial service; a viewing; burial or cremation services. The user is also provided with a basic service plan, a required services and/or optional services some of which are package arrangements. FIG. 5-12 provide an overview of the service package and options for the available combinations of the selected memorial service/viewing/burial arrangement. It should be noted that “Wizard” as depicted in various drawings refer to a software application that records and/tracks various options that a specific user selects.

Users planning immediate arrangements may also create an obituary which may include funeral information or charitable information. After identifying the appropriate geographic area and entering information as this religious denominator consumers will then process a form containing their choices, in particular, geographical and religious, submitted in response to the primary questions and the resulting package of services and cost information are provided to the user for review. The present invention provides the user either by e-mail, fax and/or phone appropriate service arrangements within the parameters that were chosen, which may include any one or more criterion, such as geographic proximity, price or quality of services.

Preferably the user can then make changes to the selections if desired. The user may also view the selected funeral home's web page and/or take a virtual tour of their facilities. Finally, the package of services selected is delivered to the Member Merchant in the user specified geographical location for the delivery of the goods and/or services. Delivery of the goods or the providing of services will be the sole responsibility of the merchants receiving and servicing the orders. Preferably, the present invention does not involve warehousing of any goods.

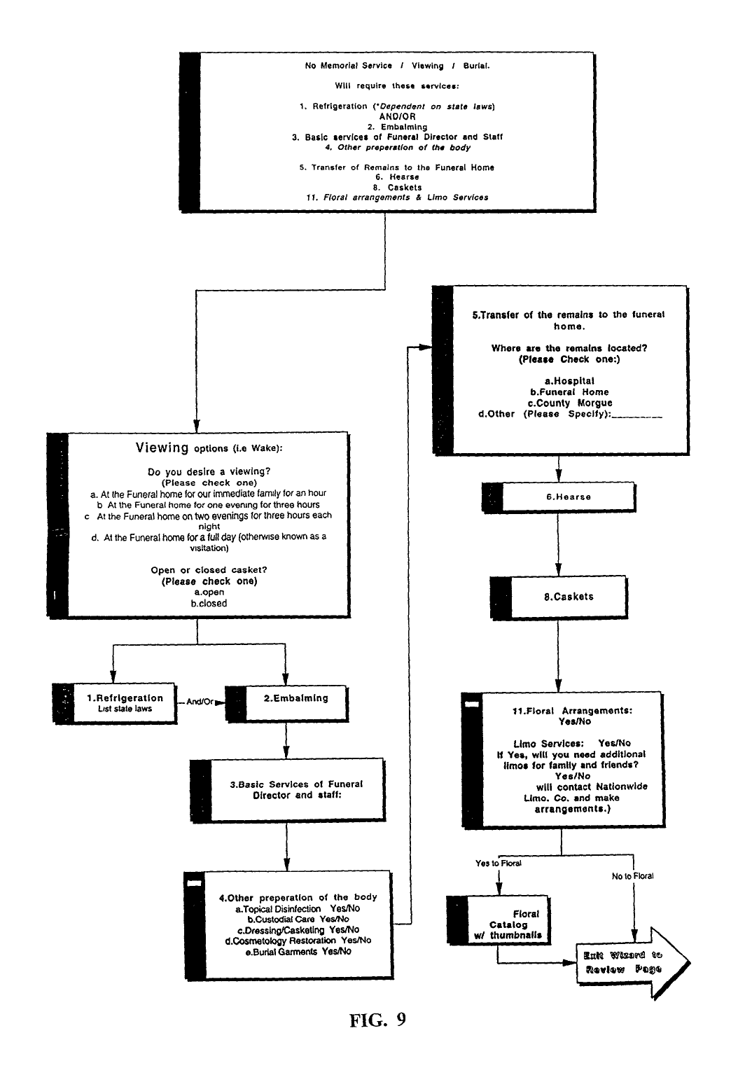

Referring back to FIG. 3, the user planning for the future is provided with options to arrange a funeral and/or burial services; to purchase insurance; (see FIG. 9). Pre-arranged plans enable users to establish in advance and prepay for the type of services to be performed and the products to be used. The cost of such services and products are preferably fixed by contract. They are preferably set at the prevailing costs at the time of execution of the contract, and not at the time the services are to be performed or products are to be delivered. Besides securing a lower price, pre-arrangement permits families to eliminate the emotional strain of making death care decisions at a time of need. Pre-planning services will be ordered via the same process as above in the immediate section, except that a trust fund, insurance or consumer financing may back the consumer's purchase. The consumer can choose between either a traditional funeral service or a cremation. Either choice will carry a list of options with a description of each option as explained above. Users also have the option of purchasing insurance. In the pre-planning insurance category, consumers are able to choose between various forms of insurance which will cover funeral costs in the future as well as fixing the cost of funeral arrangements in the future through a pre-planning arrangement. The present invention may also assist consumers to preplan and pay for a funeral both for immediate needs, and pre-arrangements though either the purchase of insurance products and/or the transfer of moneys into trust and/or consumer financing and/or immediate payment by check or credit. Consumers will then process the form containing their choices and enter either a zip code or county in which they want services to be performed as well as their religious denomination, if any, as explained above. Thereafter, the present invention will match the requested funeral to a funeral home in appropriate geographic proximity for the services to be performed with exact pricing.

As a first step in making funeral arrangements users are provided the choice of whether a memorial service will be held. Referring to FIGS. 5-8, if a memorial service is to be held, the MWS allows the consumer to choose where the memorial service will take place. For example, the user may choose to hold the service: (a) at a funeral home; (b)at a house of worship; or (c) at a grave site.

Next, the user is provided the option of having a viewing. Referring to FIGS. 5, 6, 9 and 10, if the user desires a viewing, the user may choose from several options designating the location, timing, duration and type of viewing to be held. For example, the user may choose to have a viewing at the funeral home: (a) for an hour for immediately family; (b) for one evening for three hours; (c) on two evenings for three hours each night; or (d) for a full day. The user may also choose whether to have an open or closed casket.

Next, the user is provided with other options for the preparation of the body. For instance, the user may choose whether to have: (a) topical disinfection performed; (b) custodial care; (c) dressing or casketing; (d) cosmetology restoration; or (e) burial garments.

Next the user can choose between either a traditional burial service or a cremation. The basic services of a funeral director and staff as well as the transfer of the remains are provided for either selection. Next, the MWS provides the user with the refrigeration and/or embalming requirements. In this regard, the MWS preferably queries a list of state and/or local laws pertaining to the user selections which may be stored in legal matter database 23. Also, the user can specify where the remains are located so that the remains are transferred directly to the funeral home.

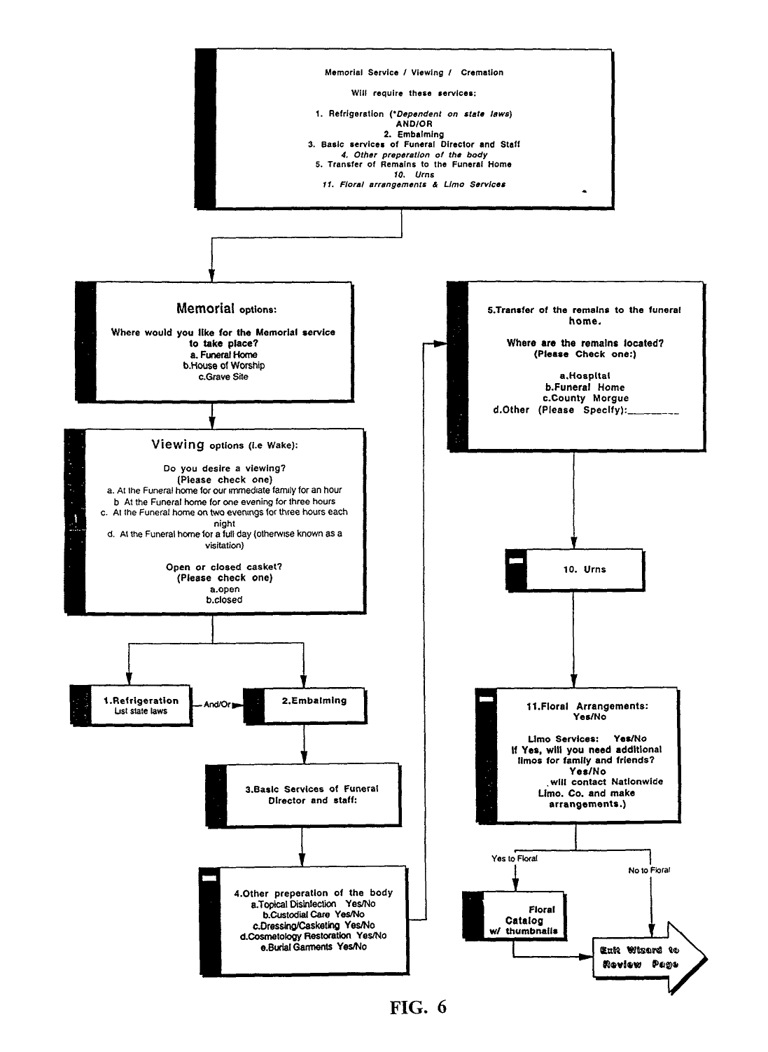

Referring to FIGS. 5, 7, 9 and 11, if the user chooses a traditional burial, the user is provided with options for securing a hearse and for buying a casket. Referring to FIGS. 6, 10 and 12, if the user chooses a cremation service, the user is presented with options for cremation providers as well as for purchasing urns. A priest, rabbi or other minister may also be selected to administer the services.

After the selection of the type of burial, the user is then provided with the option of purchasing floral arrangements and securing limousine service. If floral arrangements are desired, the user is preferably presented with an online catalog including thumbnail sized photographs of the arrangements to help the user select. The floral arrangement catalog may be stored in the service provider database or may be stored on a cd-rom provided by a service provider.

The present invention may also offer to consumers the option to finance their purchases. The user is provided with a financing option requiring registration 113. If the user wishes to finance the cost of the selected services the user may choose to register and will complete an application form on-line which can be approved or denied depending upon the user's credit-worthiness. Creditworthy borrowers will be allowed to borrow up to a certain limit for the purpose of purchasing death related goods and services. Such credit can be both for immediate needs and pre-arrangements through either the purchase of insurance products and/or the transfer of moneys into trust and/or consumer financing and/or immediate payment by check or credit.

The present invention may further provide online funeral advisors to answer questions either through e-mail, telephone or any other type of communication. In this regard, the MWS may have a Consumer Care Center (“CCC”) that acts as an independent intermediary for providing personal attention and referrals to consumers as they request it, throughout the funeral arrangement process. Full contact between the funeral operator and the family is provided either through telephone communication, e-mail, or web postings on a dedicated bulletin board.

In another embodiment, the present invention provides a MWS suitable to serve different cultures which communicate in differing languages. In this regard the MWS may be translated into different languages and may be tailored to incorporate death industry customs particular to each nationality.

In another embodiment, an Extranet system or a dedicated member network is provided to each Merchant Member to help track sales, inventory, customer requests, payments, and other pertinent information.

Advantageously, the present invention allows for the broadening of spectrum of services provided to the public when dealing with the subject of death as opposed to a traditional funeral home. Such services include virtual memorials, financing alternatives, funeral insurance, broadcast of funerals over a computer network or the Web and preplanning insurance. Also, the present invention allows for revenue generation in a variety of ways such as through member network fees, pre-planning insurance, flowers, wills, urn sales, casket sales, referral fees on financing, funeral insurance commissions, virtual memorials, sympathy cards, and fees on charitable contribution. Other opportunities include limousine service and actual direct funeral financing.

Although the preferred embodiments of the invention have been described in the foregoing description, it will be understood that the present invention is not limited to specific embodiments discussed herein. It should be understood that the materials used and the mechanical detail maybe slightly different or modified from the description herein without departing from the methods and composition disclosed and taught by the present invention as recited in the claims.

What is claimed is:

1. A method for making a funeral arrangement comprising:
developing a plurality of funeral arrangement options from a plurality of independent funeral service providers;
transmitting information relating to the plurality of funeral arrangement options to a remote computer;
allowing a user at the remote computer to select at one time a subset of the plurality of funeral arrangement options;
matching the selected subset to the plurality of funeral arrangement options; and
transmitting the selected subset to the funeral service providers from which the selected subset was collected.

2. The method of claim 1 further comprising:
transmitting the matched selections to the remote computer, to thereby allow the user to make further refinements on the selected subset of the options.

3. The method of claim 1 wherein the step of transmitting information to the remote computer includes:
transmitting an electronic form to be filled out at the remote computer.

4. The method of claim 1 wherein the funeral arrangement options include at least one of a funeral service, a wake service, a burial or cremation.

5. The method of claim 1 wherein at least two of the matched subset are independent providers.

6. The method of claim 4 wherein, if and only if the funeral service is selected by the user, the funeral arrangement options further include preparing the funeral service at one of funeral home, house of worship or burial site.

7. The method of claim 1 further comprising:
providing price information to the remote computer based on the selected subset of the plurality of options.

8. The method of claim 1 wherein the matching of the selected subset of funeral arrangement options is based of one or more of the criteria of geographic proximity, quality or price.

9. The method of claim 3 where the user at a remote computer is able to weight his or her preferences among the criteria of geographic proximity, quality and price.

10. A system for making a funeral arrangement comprising:
a database configured to store a plurality of funeral arrangement options collected from a plurality of funeral service providers;
a server computer coupled to the database and configured to transmit information relating to the plurality of funeral arrangement options to a user;
the server computer further configured to receive a subset of the plurality of funeral arrangement options entered by the user;
the server computer further configured to match the selected subset to the plurality of funeral arrangement options; and
the server computer further configured to transmit the selected subset to the funeral service provider from which the selected subset was collected.

11. The system of claim 10 wherein the server computer is further configured to transmit the matched selections to the remote computer, to thereby allow the user to make further refinements on the selected subset of the options.

12. The system of claim 10 wherein at least two of the matched subset are independent providers.

13. The system of claim 11 wherein the server computer is further configured to transmit an electronic form to be filled out at the remote computer.

14. The system of claim 11 wherein the server computer is further configured to provide at least one of a funeral service, a wake service, a burial site and cremation as the funeral arrangement options.

15. The system of claim 10 wherein the server computer is further configured to provide holding the funeral service under one of a plurality of religious denominations as the funeral arrangement options if and only if the house of worship is selected by the user.

16. The system of claim 10 wherein the database is further configured to include price information for each of the options, and wherein the server computer is further configured to provide the price information of the selected subset options to the remote computer.

17. The system of claim 10 wherein the database is further configured such that the matching of the selected subset of funeral arrangement options is based on one or more of the criteria of geographic proximity, quality or price.

18. The method of claim 10 wherein the database is further configured such that the user at a remote computer is able to weight his or her preferences among the criteria of geographic proximity, quality and price.
